(19) United States
(12) Patent Application Publication
(10) Pub. No.: US 2005/0191757 A1
(43) Pub. Date: Sep. 1, 2005

(54) Method and apparatus for detecting humans and human remains

(76) Inventors: Richard J. Melker, Gainesville, FL (US); Bruce Goldberger, Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/039,111

(22) Filed: Jan. 19, 2005

Related U.S. Application Data
(60) Provisional application No. 60/537,945, filed on Jan. 20, 2004.

(51) Int. Cl. G01N 21/00

(52) U.S. Cl. 436/164

(57) ABSTRACT

The present invention includes a method and apparatus for detecting humans or human remains by analyzing air, fluid, or soil using electronic sensor technology, including surface acoustic-wave gas sensor technology. The method determines the presence and concentration of the target compound (or a class of compounds) associated with humans or human decomposition. Diagnostic software is used to identify target compounds where a stored library of signatures is compared to the signature obtained from the system. Signal processing and neural networks are preferably utilized in the analysis.

### CROSS-REFERENCE TO RELATED APPLICATION

This application claims the benefit of U.S. provisional application Ser. No. 60/537,945, filed Jan. 20, 2004, which is hereby incorporated by reference in its entirety.

### FIELD OF INVENTION

The present invention relates to the detection of humans, and more particularly, to a method and apparatus for the detection of humans and human remains utilizing a rapidly responding device.

### BACKGROUND INFORMATION

Events occur frequently throughout the world wherein time is of the essence for human rescue and recovery of human remains. Events such as natural disasters (i.e., earthquake, landslide, flood, hurricane, tornado), building collapse, bombing or terrorist attack, accidents (i.e., airline accidents, automobile accidents), and crime (i.e., homicides) often result in missing persons (alive or dead) that require immediate recovery. Conventional methods for locating humans and human remains have been inefficient, labor-intensive, time-consuming, and non-automated, frequently requiring extensive manpower.

Often, searchers work in inclement weather conditions (i.e., storms), cramped quarters, and difficult, high-risk situations (i.e., unstable building structure), with a high risk of injury or even death. Moreover, survivors are often unconscious, badly injured, and/or unable to provide a signal regarding their location; thus, further delaying search efforts. Because trapped survivors will search for shelter, they are most often hidden under rubble, making it even more difficult for search and/or recovery teams to locate them.

In cases where a search is conducted for a criminally buried or hidden corpse, a great deal of time and manpower is required from law enforcement agencies. When available, specially trained dogs that can detect humans and human corpses via their sense of smell are employed. Such dogs may improve the probability of finding a survivor or human corpse; however, their efforts can be inconsistent and success is uncertain.

In searches for victims in waters, time-consuming and/or ineffective methods such as physically “dragging” a snaring device through the water or visual inspection by divers (who generally require support personnel and watercraft) are often employed. In addition, electronic and/or sonar-type devices are sometimes operated from the surface in attempts to detect victims/bodies. Such devices, however, often inaccurately locate solid debris rather than human bodies and/or require clear water to function properly for visual inspection using a video-type monitor that must remain on the surface. Generally, submerged victims in waters are located only after extended, costly, time-consuming searches; or, they are never recovered at all.

With regard to recovery of human remains, current methods involve the utilization of imaging technology to locate buried human remains. For example, ground-penetrating radar (GPR) has been used (see Hammon III, W. S. et al., “Forensic GPR: finite-difference simulations of responses from buried human remains,” J Applied Geophysics, 45:171-186 (2000); and Mellett, J. S., “GPR in forensic and archeological work: hits and misses,” Proceedings, SAGEEP, Envir. Eng. Geophys. Soc., 487-491 (1996)) to provide an image of contents or disturbances beneath the ground. Such devices, however, do not provide clear resolution of human body features while maintaining effective signal attenuation. Thus, these devices are not well suited for broad reconnaissance surveys for potential areas in which human remains might be buried.

Diffuse reflectance infrared spectroscopy has been proposed for use in studying soil samples to identify whether human remains are present (see Stuart, B. H. et al., “Studies of adipocere using diffuse reflectance infrared spectroscopy,” Vibrational Spectroscopy, 24:233-242 (2000)). Adipocere, which is a waxy substance formed from tissue of dead bodies, can be detected in soil samples using an infrared reflectance technique. This methodology, however, does not accurately identify the specific location in which human remains are buried.

The use of bacterial strains responsive to compounds associated with human decomposition have been proposed for use in providing a fluorescent bioreporter to detect decaying human remains (see Vass, A. et al., “Detection of Buried Human Remains Using Bioreporter Fluorescence,” U.S. Dept. of Energy Report, Y/NSP-726 (2001)). This method requires the identification, isolation, and culture of bacterial strains that respond to putrescine or cadaverine, compounds associated with decomposition events. In addition, the bacteria are mutated to include a bioreporter gene (a gene that is expressed and produces a detectable signal, i.e., fluorescent or bioluminescent response) that is activated when in the presence of putrescine or cadaverine. Unfortunately, the process for deriving such bacteria is time-consuming and cost-prohibitive.

In certain instances, gas sensors have been proposed for use in detecting human remains (see U.S. patent applications Ser. Nos. 2001/0055544 and 2002/0007687; and International Application Publication No. WO 00/25108). With the 2001/0055544 and WO 00/25108 applications, general gas sensors are proposed for use in detecting a combination of volatile gases (i.e., ammonia, methane) that may or may not be specific to human decomposition. Because such devices require the presence of several volatile gases at high concentrations and use gas sensors that are neither highly specific nor sensitive to certain volatile gases, they would not provide an effective nor accurate means for identifying human remains. The 2002/0007687 application discloses the use of a rope-like structure to attract analytes of interest, which can then be examined using an appropriate analysis process (i.e., absorption spectroscopy). The rope-like collection structure must, however, be properly aligned and laid out to amass an effective amount of analyte for analysis. Besides being time-consuming, this method is inefficient.

Aptamers have recently been identified as potentially effective sensors for molecules and compounds of scientific and commercial interest (see Brody, E. N. and L. Gold, “Aptamers as therapeutic and diagnostic agents,” J. Biotechnol., 74(1):5-13 (2000) and Brody et al., “The use of aptamers in large arrays for molecular diagnostics,” Mol. Diagn., 4(4):381-8 (1999)). For example, aptamers have demonstrated greater specificity and robustness than antibody-based diagnostic technologies. In contrast to antibodies, whose identification and production completely rest on animals and/or cultured cells, both the identification and production of aptamers takes place in vitro without any requirement for animals or cells.

Aptamer synthesis is potentially far cheaper and reproducible than antibody-based diagnostic tests. Aptamers are produced by solid phase chemical synthesis, an accurate and reproducible process with consistency among production batches. An aptamer can be produced in large quantities by polymerase chain reaction (PCR) and once the sequence is known, can be assembled from individual naturally occurring nucleotides and/or synthetic nucleotides. Aptamers are stable to long-term storage at room temperature, and, if denatured, aptamers can easily be renatured, a feature not shared by antibodies. Furthermore, aptamers have the potential to measure concentrations of ligand in orders of magnitude lower (parts per trillion or even quadrillion) than those antibody-based diagnostic tests. These inherent characteristics of aptamers make them attractive for diagnostic applications.

A number of “molecular beacons” (often fluorescence compounds) can be attached to aptamers to provide a means for signaling the presence of and quantifying a target chemical or biological agent. For instance, an aptamer specific for cocaine has recently been synthesized (Stojanovic, M. N. et al., “Aptamer-based folding fluorescent sensor for cocaine,” J. Am. Chem. Soc., 123(21):4928:31 (2001)). A fluorescence beacon, which quenches when cocaine is reversibly bound to the aptamer is used with a photodetector to quantify the concentration of cocaine present. Aptamer-based biosensors can be used repeatedly, in contrast to antibody-based tests that can be used only once.

Of particular interest as a beacon are amplifying fluorescent polymers (AFP). AFPs with a high specificity to TNT and DNT have been developed. Interestingly, a detector based on AFP technology also detects propofol, an intravenous anesthetic agent, in extremely low concentration. The combination of AFP and aptamer technologies holds the promise of robust, reusable biosensors that can detect compounds in minute concentrations with high specificity.

Accordingly, there is an urgent need to develop a means to accurately detect humans and/or human remains in real-time, especially for use by search and recovery personnel. Because the environment or terrain is often dangerous for both human and animal search and recovery personnel, there is also an urgent need for a portable mechanized device (i.e., hand-held or robotic) that can efficiently and accurately detect humans and/or human remains in different conditions.

### BRIEF SUMMARY OF THE INVENTION

The present invention solves the problems in the art by providing a method and apparatus for detecting humans and/or human remains by providing a device for analyzing compounds associated with humans to confirm the location of the human (or human remains). The compounds detected by the present invention include those compounds associated with humans or human decomposition such as, without limitation, cadaverine, putrescine, alanine, aspartate, cysteine, gamma amino butyric acid (GABA), glutamate, glutamine, glycine, histidine, isoleucine, leucine, methionine, oxalic acid, phenylalanine, praline, serine, threonine, tyrosine, valine, asparginine, tryptophan, lysine, and gamma hydroxybutyric acid (GHB), compounds detectable in bodily fluids including sweat (5-alpha-androst-16-en-3-one (androstenone), squalene), urine, stool, or breath (carbon dioxide, for example).

Generally, the parts of the human body where compounds exist that are most likely to be detected by the human nose are the armpits and the genital areas. Both of these areas contain especially rich populations of eccrine sweat glands, which produce moisture; sebaceous glands, which produce oils that bacteria turn into carboxylic acids; and apocrine glands, which produce steroid-like odor molecules similar to those that have been implicated in forming the individual scents of animals. Researchers have found that carboxylic acids and odiferous steroids are among the most important parts of human scent. Historically, scientists believed that decaying bodies released only a few ephemeral compounds, apart from cadaverine and putrescine, such as methane, ammonia, carbon dioxide and hydrogen sulfide. However, scientists have since identified about 450 compounds that are released by decaying bodies.

As used throughout the application and claims, reference to compounds associated with human decomposition is intended to include, without limitation, the compounds described above (such as cadaverine, putrescine, alanine, carboxylic acids, etc.).

The advantages of the subject invention are numerous. First, the invention provides for a method by which search and recovery personnel can readily determine the location of a human or human remains. A resulting advantage of the ability to rapidly locate a human or human remains through a simple and efficient system is the ability to timely recover and identify the human/human remains. The subject technology for the present invention is inexpensive and has broad forensic application for detecting a wide range of compounds.

In operation, the analysis of either air, fluid, or soil samples are assessed using sensors in accordance with the subject invention. The method may further include the step of capturing the sample of air, fluid, or soil in a vessel prior to analysis as well as dehumidifying the air prior to analysis in a manner well known in the art.

The system of the subject invention is particularly advantageous as a result of its high degree of sensitivity and specificity for compounds associated with humans and human decomposition. Accordingly, even minute concentrations of target compounds (associated with decomposition or humans) in air, fluid, or soil are readily detected by the subject invention.

In a preferred embodiment, the air, fluid, or soil sample is analyzed using sensor technology selected from semiconductor gas sensor technology, conductive polymer gas sensor technology, surface acoustic wave gas sensor technology, aptamers and aptamer-based sensors, and amplifying fluorescent polymer (AFP) sensors. According to the subject invention, the sensor technology produces a unique electronic fingerprint to characterize the target compound such that the presence (and, when required, concentration) of the target compound is determined.

The preferred device of the present invention includes (a) a sensor having a surface exposed to air, fluid, or soil sample and comprising a material selectively adsorptive of a chemical substance or group of substances; and (b) an analyzer, coupled to the sensor, for producing an electrical signal indicative of the presence of the substance. The analyzer can be further operative to determine the approximate concentration of the substance.

In one embodiment, the sensor is a surface acoustic wave device, such as that disclosed in U.S. Pat. No. 5,945,069. The device detects a target substance in an air, fluid, or soil sample having the following components: (a) a surface-acoustic wave sensor capable of detecting the presence of the target compound associated with humans or human decomposition, wherein the sensor responds to the target compound by a shift in the resonant frequency; (b) an oscillator circuit having the sensor as an active feedback element; (c) a frequency counter in communication with the oscillator circuit to measure oscillation frequency which corresponds to resonant frequency of the sensor; and (d) a processor for comparing the oscillation frequency with a previously measured oscillation frequency of the target compound and determining the presence and, optionally, the concentration of the target compound therefrom.

In an alternate embodiment, the sensing device of the subject invention detects a target compound in air, fluid, or soil, with the following components: (a) a sensor having an array of polymers, antibodies, and/or aptamers capable of detecting the presence of the target compound, wherein the sensor responds to the target compound by changing the resistance in each polymer, antibody, or aptamer, resulting in a pattern change in the sensor array; (b) a processor for receiving the change in resistance, comparing the change in resistance with a previously measured change in resistance, and identifying the presence of the target compound from the pattern change and the concentration of the compound from the amplitude. The processor can include a neural network for comparing the change in resistance with a previously measured change in resistance to find a best match.

The device may also include a means for receiving a sample of air, fluid (i.e., gas or liquid), or soil. Preferably the device comprises sensor technology selected from semiconductor gas sensor technology, conductive polymer gas sensor technology, or surface acoustic wave gas sensor technology.

In alternate embodiments, air, fluid, or soil is analyzed to confirm the presence of a target compound associated with humans or human decomposition by a spectrophotometer or a mass spectrometer.

The device of the present invention can be portable (i.e., hand-held) or robotic in nature. It can include means for providing location coordinates (i.e., GPS system) to search and recovery personnel.

The method further includes the step of recording data resulting from analysis of the air, fluid, or soil. The method further includes the step of transmitting data resulting from analysis of the air, fluid, or soil.

Accordingly, it is an object of the present invention to detect target compounds, such as compounds associated with decomposition, by methods including, but not limited to, analysis via sensor technologies (i.e., silicon chip technology).

It is a further object of the present invention to provide a reporting system capable of tracking results and alerting search and recovery officials.

Further objects and advantages of the present invention will become apparent by reference to the following detailed description of the invention and appended drawings.

### BRIEF DESCRIPTION OF THE DRAWINGS

FIG. 1 is a view of a gas sensor chip in accordance with the present invention.

FIG. 2 is a view of a chemoselective polymer coated SAW sensor designed for the detection and measurement of a target compound in accordance with the present invention.

FIG. 3 is a view, in cross-section and broken away, of a SAW sensor in accordance with the present invention.

FIG. 4 is a schematic representative of a surface-acoustic wave (SAW) multi-polymeric channel sensor array.

### DETAILED DESCRIPTION OF THE INVENTION

The present invention provides a method and apparatus for the rapid and accurate detection of target compounds associated with humans and/or human decomposition. The target compound is detected using devices including, but not limited to, electronic noses, spectrophotometers to detect the substance's IR, UV, or visible absorbance or fluorescence, or mass spectrometers to detect the compound's characteristic mass spectra.

The invention preferably provides methods by which search and recovery personnel can readily determine the location of a human or human remains. A resulting advantage of the ability to rapidly locate a human or human remains through a simple and efficient system is the ability to timely recover and identify the human/human remains.

In other embodiments, the methods of the invention are directed to monitoring and/or security industries. For example, the system and methods of the invention can be incorporated into security systems that monitor human or animal trespass into occupied or unoccupied structures (such as a residential home, warehouse, etc.) and areas (such as large acres of land). In a related embodiment, the systems and methods of the invention are incorporated into burglar alarms for use in detecting an intruder in a residential or business structure. The burglar alarms can further include cameras to aid in identifying the intruder.

In a related embodiment, the system and methods of the invention can also be used to monitor livestock and other animal movements. For example, the number of instances an endangered animal or cattle enters a grazing area can be monitored using the systems and methods of the invention.

Sensor Technology

Sensor technology is used by the present invention to detect the presence of target compound in air, fluid (i.e., gas or liquid), or soil. The detection of a target compound signifies the presence of a human or cadaver.

In one embodiment, the present invention contemplates using sensor technology based on surface acoustic wave (SAW) sensors. These sensors oscillate at high frequencies and respond to perturbations proportional to the mass load of certain molecules. This occurs in the vapor phase on the sensor surface. The resulting frequency shift is detected and measured by a computer. Usually, an array of sensors (4-6) is used, each coated with a different chemoselective polymer that selectively binds and/or absorbs vapors of specific classes of molecules. The resulting array, or “signature” identifies specific target compounds. Sensitivity of the arrays is dependent upon the homogeneity and thickness of the polymer coating.

Surface-acoustic-wave (SAW) gas-sensors generally include a substrate with piezoelectric characteristics covered by a polymer coating, which is able to selectively adsorb a target compound. The variation of the resulting mass leads to a variation of its resonant frequency. This type of sensor provides very good mass-volume measures of the target compounds. In the SAW device, a surface acoustic wave is propagated between sets of interdigitated electrodes by means of an oscillator. The chemoselective material is coated on the surface of the transducer. When a target compound interacts with the chemoselective material coated on the substrate, the interaction results in a change in the SAW properties, such as the amplitude or velocity of the propagated wave. The detectable change in the characteristics of the wave indicates the presence and concentration of the target compound (and thus providing a means for locating the human or human remains).

Uniformity of the chemoselective coating is a critical factor in the performance of a sensor. Changes in surface area can greatly affect the local vibrational signature of the SAW device. Therefore, films should be deposited that are consistent to within 1 nm with a thickness of 15-25 nm. In this regard, it is important that the coating be uniform and reproducible from one device to another, but also that the coating on a single device be uniform across the active area of the substrate. This ensures that a set of devices will all operate with the same sensitivity. If a coating is non-uniform, the response time to target compound exposure and the recovery time after target compound exposure are increased and the operating performance of the sensor is impaired. The thin areas of the coating respond more rapidly to a target compound than the thick areas. As a result, the sensor response signal takes longer to reach an equilibrium value, and the results are less accurate than they would be with a uniform coating.

Most current technologies for creating large area films of polymers and biomaterials involve spinning, spraying, or dipping a substrate into a solution of the macromolecule and a volatile solvent. These methods coat the entire substrate without selectivity and sometimes lead to solvent contamination and morphological inhomogeneities in the film due to non-uniform solvent evaporation. There are also techniques such as microcontact printing and hydrogel stamping that enable small areas of biomolecular and polymer monolayers to be patterned, but separate techniques like photolithography or chemical vapor deposition are needed to transform these films into microdevices. Other techniques such as thermal evaporation and pulsed laser ablation are limited to polymers that are stable and not denatured by vigorous thermal processes.

More precise and accurate control over the thickness and uniformity of a film coating may be achieved by using pulsed laser deposition (PLD), a physical vapor deposition technique that has been developed recently for forming ceramic coatings on substrates. By this method, a target comprising the stoichiometric chemical composition of the material to be used for the coating is ablated by means of a pulsed laser, forming a plume of ablated material that becomes deposited on the substrate.

Polymer thin films, using a new laser based technique developed by researchers at the Naval Research Laboratory called Matrix Assisted Pulsed Laser Evaporation (MAPLE), have recently been shown to increase sensitivity and specificity of chemoselective SAW vapor sensors. A variation of this technique, Pulsed Laser Assisted Surface Functionalization (PLASF) is preferably used to design compound specific sensor coatings with increased sensitivity for the present invention. PLASF produces similar thin films for sensor applications with bound receptors or antibodies for sensor applications. This provides improved SAW biosensor response by eliminating film imperfections induced by solvent evaporation and detecting molecular attachments to specific antibodies. This results in high sensitivity and specificity.

A SAW vapor sensing device has been disclosed in which a layer of antibodies are attached to a surface of the SAW sensor (see Stubbs, D D et al., “Investigation of Cocaine Plumes Using Surface Acoustic Wave Immunoassay Sensors,” Anal. Chem., 75:6231-6235 (2003)). When a target antigen reacts with an antibody, the acoustic velocity is altered, causing an oscillator frequency of the SAW to shift to a different value. The subject invention contemplates usage of such SAW devices, as well as those SAW sensing devices in which aptamers (including indicator aptamers), molecular beacons, and other known detectors are utilized to coat a surface of the SAW sensor.

Certain embodiments use known SAW devices described in numerous patents and publications, including U.S. Pat. Nos. 4,312,228 and 4,895,017, and Groves W. A. et al., “Analyzing organic vapors in exhaled breath using surface acoustic wave sensor array with preconcentration: Selection and characterization of the preconcentrator adsorbent,” Analytica Chimica Acta, 371:131-143 (1988).

Other embodiments can apply SAW devices and/or other acoustic transducer devices to identify particle bond rupture for use in detecting different target molecules. Such detection methods, which can be applied to the methods of the present invention, are described in U.S. Pat. No. 6,589,727.

Other types of chemical sensors known in the art that use chemoselective coating applicable to the operation of the present invention include bulk acoustic wave (BAW) devices, plate acoustic wave devices, interdigitated microelectrode (IME) devices, optical waveguide (OW) devices, electrochemical sensors, and electrically conducting sensors.

In another embodiment, the invention uses fluid sensor technology, such as commercial devices known as “artificial noses,” “electronic noses,” or “electronic tongues.” These devices are capable of qualitative and/or quantitative analysis of simple or complex gases, vapors, odors, liquids, or solutions. A number of patents and patent applications which describe fluid sensor technology include the following: U.S. Pat. Nos. 5,945,069; 5,918,257; 5,891,398; 5,830,412; 5,783,154; 5,756,879; 5,605,612; 5,252,292; 5,145,645; 5,071,770; 5,034,192; 4,938,928; and 4,992,244; and U.S. patent application No. 2001/0050228. Certain sensitive, commercial off-the-shelf electronic noses, such as those provided by Cyrano Sciences, Inc. (“CSI”) (i.e., CSI's portable Electronic Nose and CSI's Nose-Chip™ integrated circuit for odor-sensing—U.S. Pat. No. 5,945,069), can be used in the present invention to detect the presence of target compounds in samples of air, fluid, or soil.

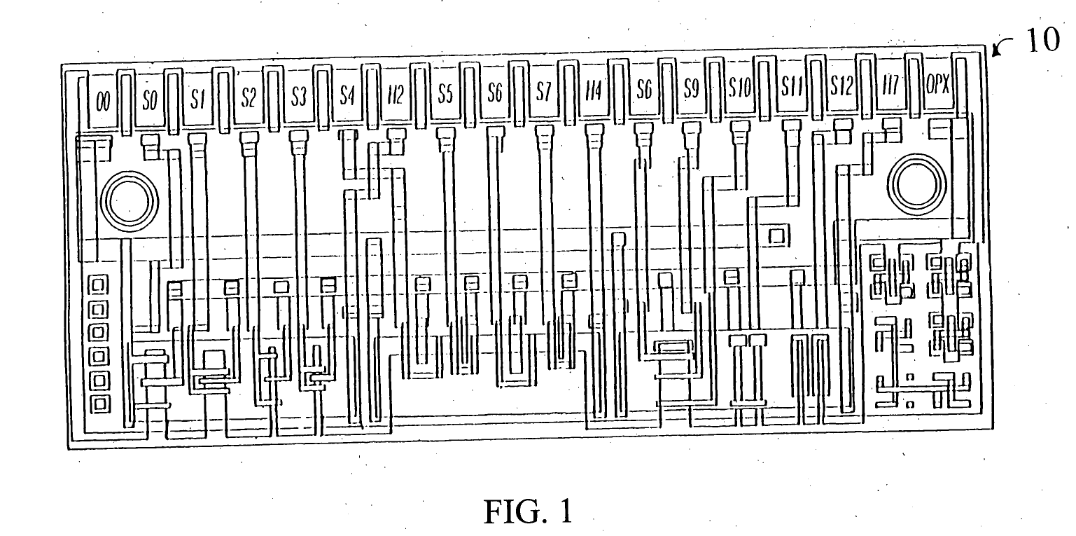

As illustrated in FIG. 1, an “electronic nose” sensor according to the present invention analyzes the air to detect the presence of any compounds associated with humans or human decomposition. These devices offer minimal cycle time, can detect multiple odors, can work in almost any environment without special sample preparation or isolation conditions, and do not require advanced sensor design or cleansing between tests.

Other embodiments of the present invention use sensor technology selected from semiconductive gas sensors; mass spectrometers; and IR, UV, visible, or fluorescence spectrophotometers. With these sensors, a target compound changes the electrical properties of the semiconductors by making their electrical resistance vary, and the measurement of these alternatives allows the determination of the concentration of target compounds present in the sample. The methods and apparatus used for detecting target compounds generally have a brief detection time of a few seconds.

Additional recent sensor technologies included in the present invention include apparatuses having conductive-polymer gas-sensors (“polymeric”), aptamer biosensors, and amplifying fluorescent polymer (AFP) sensors.

Conductive-polymer gas-sensors (also referred to as “chemoresistors”) are coated with a film sensitive to the molecules of certain detectable target compounds. On contact with the molecules, the electric resistance of the sensors changes and the measurement of the variation of this resistance enables determination of the concentration of the target compound (i.e., cadaverine or putrescine) to establish the presence and/or location of a human or human remains. An advantage of this type of sensor is that it functions at temperatures close to ambient. Different sensitivities for detecting different detectable compounds can be obtained by modifying or choosing an alternate conductive polymer.

Polymeric gas sensors can be built into an array of sensors, where each sensor responds to different gases and augments the selectivity of the target compound.

Aptamer biosensors can be utilized in the present invention for detecting the presence of target compounds associated with humans or human decomposition in samples of air, fluid, or soil. Aptamer-based sensors can include resonant oscillating quartz sensors that can detect minute changes in resonance frequencies due to modulations of mass of the oscillating system, which results from a binding or dissociation event.

Similarly, amplifying fluorescent polymer (AFP) sensors may be utilized in the present invention for detecting the presence of target compounds in samples of air, fluid, or soil. AFP sensors are extremely sensitive and highly selective chemosensors that use amplifying fluorescent polymers. When vapors bind to thin films of the polymers, the fluorescence of the film decreases. A single molecule binding event quenches the fluorescence of many polymer repeat units, resulting in an amplification of the quenching. The binding of target compounds to the film is reversible, therefore the films can be reused.

In accordance with the present invention, competitive binding immunoassays can be used to test a sample of air, fluid, or soil for the presence of target compounds associated with humans or human remains. Immunoassay tests generally include an absorbent, fibrous strip having one or more reagents incorporated at specific zones on the strip. The sample (or air, fluid, and/or soil) is deposited on the strip and by capillary action the sample migrates along the strip, entering specific reagent zones in which a chemical reaction may take place. At least one reagent is included which manifests a detectable response, for example a color change, in the presence of a minimal amount of a target compound associated with humans or human remains. Patents that describe immunoassay technology include the following: U.S. Pat. Nos. 5,262,333 and 5,573,955.

Other embodiments of the present invention use flow cytometers to analyze air, fluid, or soil samples for target compounds associated with humans or human remains. Flow cytometry is a technique that is used to determine certain physical and chemical properties of microscopic biological particles by sensing certain optical properties of the particles. To do so, the particles are arranged in single file using hydrodynamic focusing within a sheath fluid. The particles are then individually interrogated by a light beam. Each particle scatters the light beam and produces a scatter profile. The scatter profile is often identified by measuring the light intensity at different scatter angles. Certain physical and/or chemical properties of each particle can then be determined from the scatter profile. Patents that describe flow cytometry technology include the following: U.S. Pat. Nos. 6,597,438; 6,097,485; 6,007,775; and 5,716,852.

Other technologies and methods are contemplated herein for detection of target compounds. For example, an air sample can be captured in a container (vessel) for later analysis at a central instrument such as a mass spectrometer.

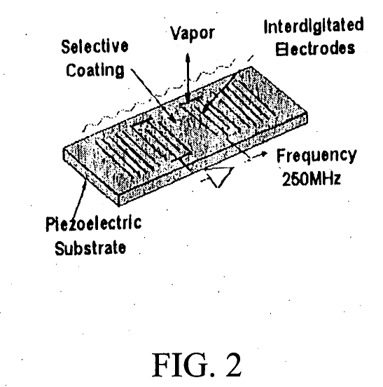

As illustrated in FIG. 2, a chemoselective polymer coated SAW sensor can be used to detect the presence of a target compound associated with humans or human remains in a sample of air, fluid, or soil.

In the present invention, vapor concentration measurements of target compounds are made by detecting the adsorption of molecules onto the surface of a SAW sensor coated with a polymer thin film. This thin film is specifically coated to provide selectivity and sensitivity to specific target compounds associated with humans or human decomposition. The SAW is inserted as an active feedback element in an oscillator circuit. A frequency counter measures the oscillation frequency, which corresponds to the resonant frequency of the SAW sensor. The response of the SAW sensor to the target compound is measured as a shift in the resonant frequency of the SAW sensor. This configuration requires an oscillator circuit, the coated SAW sensor, and a frequency counter, all of which can be housed on a small printed circuit board.

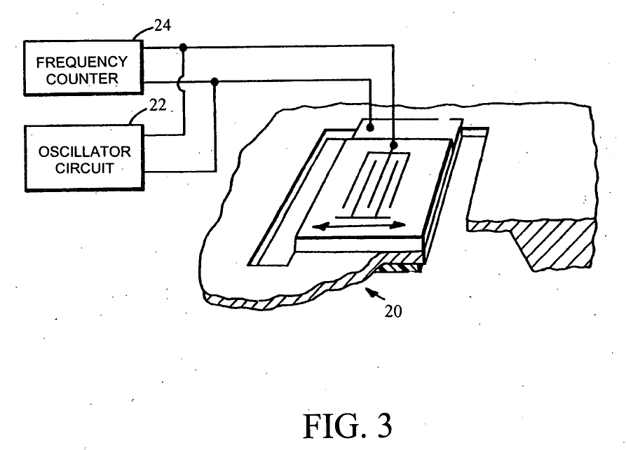

FIG. 3 shows an example of a device for detecting a target compound in air, having the following components: (a) a surface-acoustic wave sensor 20 capable of detecting the presence of the target compound, wherein the surface-acoustic wave sensor 20 is exposed to an environment to be sampled, and wherein the sensor responds to the target substance by a shift in the resonant frequency; (b) an oscillator circuit 22 having the sensor as an active feedback element; (c) a frequency counter 24 in communication with the oscillator circuit to measure oscillation frequency which corresponds to resonant frequency of the sensor; and (d) a processor (not shown) for comparing the oscillation frequency with a previously measured oscillation frequency of the target compound and determining presence and concentration of the target compound therefrom. The sensor can include measuring circuitry (not shown) and an output device (not shown) can also be included (i.e., screen display, audible output, printer).

The processor can include a neural network (not shown) for pattern recognition. Artificial Neural Networks ANNs are self learning; the more data presented, the more discriminating the instrument becomes. By running many standard samples and storing results in computer memory, the application of ANN enables the device to “understand” the significance of the sensor array outputs better and to use this information for future analysis. “Learing” is achieved by varying the emphasis, or weight, that is placed on the output of one sensor versus another. The learning process is based on the mathematical, or “Euclidean,” distance between data sets. Large Euclidean distances represent significant differences in sample-to-sample aroma characteristics.

In certain embodiments, the device of the present invention is portable (i.e., hand-held) or robotic in nature. Further, the device can include a global positioning system (GPS) that can provide to the user location coordinates with respect to the detected target compounds, which are indicative of humans and/or human remains.

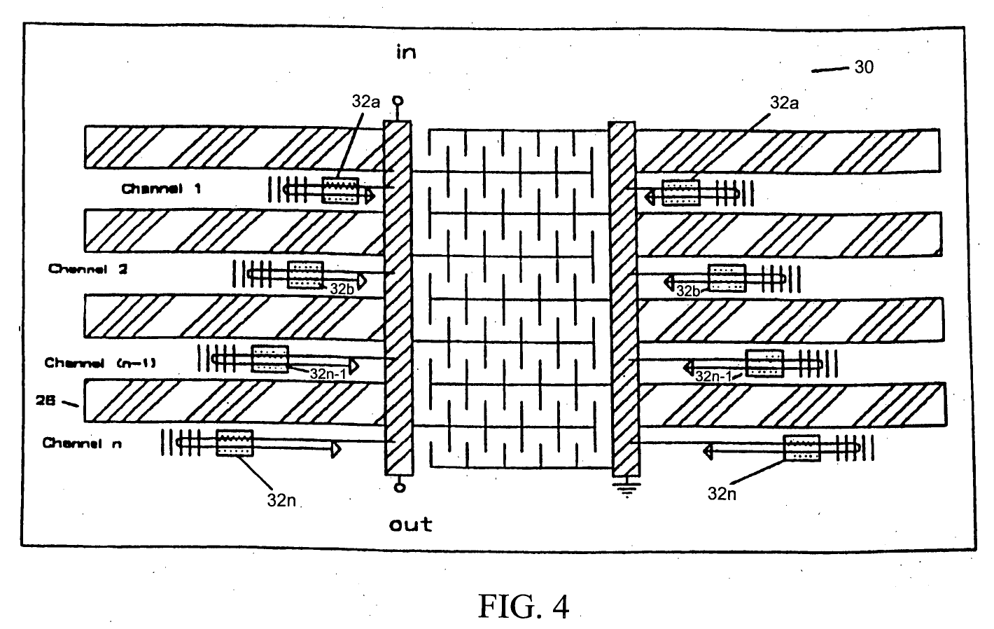

In an alternate embodiment, FIG. 4 shows an example of a device for detecting a target compound in air, fluids, or soil, having the following components: (a) a sensor 30 having an array of polymers 32a-32n capable of detecting the presence of the target compound in a sample of air, fluid, or soil, wherein the sensor responds to the target compound by changing the resistance in each polymer resulting in a pattern change in the sensor array; (b) a processor (not shown) for receiving the change in resistance, comparing the change in resistance with a previously measured change in resistance, and identifying the presence of the target compound from the pattern change and the concentration of the target compound from the amplitude. The processor can include a neural network for comparing the change in resistance with a previously measured change in resistance to find a best match (pattern recognition). The sensor can include measuring circuitry and an output device can also be included (i.e., screen display, audible output, printer).

Another preferred electronic nose technology of the present invention comprises an array of polymers, for example, 32 different polymers, each exposed to target compounds. Each of the 32 individual polymers swells differently to the target compounds creating a change in the resistance of that membrane and generating an analog voltage in response to that specific compound (“signature”). Based on the pattern change in the sensor array, the normalized change in resistance is then transmitted to a processor to identify the type, quantity, and quality of the target compound. The unique response results in a distinct electrical fingerprint characterizing the target compound. The pattern of resistance changes of the array indicates the presence of the target compound and the amplitude of the pattern indicates its concentration.

This technology can be used to identify a variety of compounds associated with humans or human decomposition by determining first the signature for each class of compounds (i.e., compounds associated with liver decomposition) as well as specific compounds associated with liver decomposition (i.e., glutamate, glutamine, proline, threonine, phenylalanine, cysteine, aspartate, methionine, valine, serine, glycine, GABA, and oxalic acid). In the case of a detector for human remains, a signature for a marker or several markers associated with human decomposition is first determined. In addition, a library of interferent signatures is created to allow the sensor to discriminate the signal reflecting detection of human remains from background noise.

The responses of the sensor technology (i.e., electronic nose) to specific substances can be fully characterized using a combination of conventional gas sensor characterization techniques. For example, the sensor can be attached to a computer where target compound analysis results are displayed on the computer screen, stored, transmitted, etc. A data analyzer compares the pattern of response to previously measured responses from known substances. The pattern matching can be performed using a number of techniques, including neural networks. By comparing the analog output from each of the 32 polymers to a “blank” or control substance, a neural network can establish a pattern, which is unique to that target compound and subsequently learns to recognize that target compound. The particular resistor geometries are selected to optimize the desired response to the particular compound being sensed. The sensor technology of the present invention is preferably an electronic nose, self-calibrating polymer system suitable for liquid or gas phase solutions for detection of a variety of target compounds simultaneously.

The electronic nose of the present invention can include integrated circuits (chips) manufactured in a modified vacuum chamber for Pulsed Laser Deposition of polymer coatings. It can operate the simultaneous thin-film deposition wave detection and obtain optimum conditions for high sensitivity of SAW sensors. The morphology and microstructure of biosensor coatings is characterized as a function of process parameters.

The electronic nose used in the present invention is preferably designed so that the device can sense target compounds in air, fluid, or soil, without having to take a sample. This, however, is not a limitation on the invention as air, fluid, or soil can be both, analyzed immediately or stored as a sample for future analysis. The output from the neural network of the modified electronic nose is similar when the air, fluid, or soil comes in direct contact with the device and when samples of air, fluid, or soil are allowed to dry, before they are analyzed by the electronic nose.

The humidity in gases represents a problem for certain electronic nose devices (not, however, SAW sensors) because they will only work with “dry” gases. When using such humidity sensitive devices, the present invention includes a means to dehumidify the air or air samples. This is accomplished by including a commercial dehumidifier or a heat moisture exchanger (HME).

Following are examples that illustrate procedures for practicing the invention. These examples should not be construed as limiting.

### EXAMPLE 1

### Detection of a Human Entrapped in Rubble

As contemplated herein, an electronic sensor device for detecting humans has an appearance and functionality similar to a metal detector, wherein the device is capable of being placed in close proximity to the ground or inside a rubble pile and contains a means for collecting ambient air. The device further includes a microprocessor, an alarm, and at least one SAW sensor coated with an aptamer specific for detectable compounds released by humans.

Specifically, the ambient air enters the device of the invention and is directed over a SAW sensor coated with an aptamer specific for androstenone, a component of sweat. In the presence of androstenone, there is a frequency shift in the SAW sensor due to the mass load of the androstenone adsorbed to the aptamer. The frequency shift is detected by the microprocessor in the device, which sounds the alarm to signal to the operator that the compound is detected.

In one embodiment, the device is designed so that the intensity of the alarm increases with increasing concentration of the specific compound to which the aptamer is designed (in this case androstenone), such that the device leads the operator to the entrapped individual.

### EXAMPLE 2

### Detection of Human Remains Buried Below the Surface of the Earth

As the human body decomposes under ground, a number of compounds are released, including cadaverine and putrescine, which slowly diffuse through the soil to the surface. In accordance with the present invention, an electronic sensor device similar in form to a metal detector is provided, wherein the device contains a sensor array with a variety of polymer coatings sensitive to compounds released by human remains. Further, the device has a microprocessor with includes at least one neural network that can recognize the “fingerprint” of target compound, i.e., cadaverine and/or putrescine.

In a method of use, a sensor device comprising (a) a sensor array with a variety of polymer coatings sensitive to cadaverine and/or putrescine; (b) a microprocessor including at least one neural network; and (c) an alarm, is provided, wherein the sensor device is passed in a grid pattern over the area where a body is suspected to have been buried. Air samples are introduced to the device so as to pass across the sensor array. When putrescine and/or cadaverine are present in the air, even in minute concentrations, the microprocessor detects the fingerprint provided by the neural network, and sounds the alarm.

In a related embodiment, the intensity of the alarm is proportional to the concentration of the compound that reacts with the sensor array. The intensity of the alarm increases with increasing compound concentration, which leads the investigators to the site where the human remains are located and can be recovered.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein, or from which a claim for benefit of priority has been made, are incorporated herein by reference in their entirety to the extent they are not inconsistent with the explicit teachings of this specification. We claim:

1. A method for detecting human remains, comprising exposing sensor technology to an environmental sample to determine the presence of target compounds associated with human remains in the environment, and using the results of the sensor technology to locate the human remains.

2. The method of claim 1 wherein said sample is analyzed to determine the presence of said target compound by sensor technology selected from the group consisting of: semiconductor gas sensor technology; conductive polymer gas sensor technology; aptamer sensor technology; amplifying fluorescent polymer (AFP) sensor technology; or surface acoustic wave gas sensor technology.

3. The method of claim 1 wherein said sample is analyzed to determine the presence of said compound by at least one surface acoustic wave gas sensor wherein the coating is produced by technology selected from the group consisting of pulsed laser deposition, matrix assisted pulsed laser evaporation, and pulsed laser assisted surface functionalization.

4. The method of claim 1 wherein the sensor technology produces a unique electronic fingerprint to characterize the target compound such that the presence and concentration of the target compound is determined.

5. The method of claim 1 wherein said sample is analyzed to confirm the presence of said target compound by a spectrophotometer.

6. The method of claim 1 wherein said sample is analyzed to confirm the presence of said target compound by a mass spectrometer.

7. The method of claim 1 further comprising the step of recording data resulting from analysis of said sample.

8. The method of claim 1 further comprising the step of communicating data resulting from analysis of said sample to a remote system.

9. The method of claim 1 further comprising the step of analyzing data resulting from analysis of said sample with a neural classifier.

10. The method of claim 1 wherein the analysis of said sample includes comparing the results sensed in said sample against a predetermined signature library of interferents.

11. The method of claim 1 wherein the analysis of said sample includes comparing the results sensed in said sample with a predetermined signature profile of a class of target compounds.

12. The method of claim 1 wherein the analysis of said sample includes comparing the results sensed in said sample with a predetermined signature profile of a specific target compound.

13. The method of claim 1 wherein said sample is obtained by capturing air in a vessel prior to analysis.

14. The method of claim 13 further comprising the step of dehumidifying said sample prior to analysis.

15. A method for determining the location of human remains, comprising:
obtaining a sample of air;
subsequently analyzing said air sample using gas sensor technology;
comparing the results of the analysis against a library of known target compounds and interferents associated with human remains; and
identifying and confirming the presence or absence of the target compound in said air.

16. A method for determining the location of a human, comprising:
obtaining a sample of air;
subsequently analyzing said air sample;
comparing the results of the analysis against a library of known target compounds and interferents associated with humans;
confirming the presence or absence of any target compounds and interferents in the air sample.

17. A device for determining the location of human remains comprising:
a surface-acoustic wave sensor capable of detecting the presence of said target compound, wherein said sensor responds to the target compound by a shift in the resonant frequency;
an oscillator circuit having said sensor as an active feedback element; and
a frequency counter in communication with said oscillator circuit to measure oscillation frequency which corresponds to resonant frequency of the sensor;
a processor for comparing the oscillation frequency with a previously measured oscillation frequency of the target compound and determining presence and concentration of the target compound therefrom.

18. A device for determining the location of human remains comprising:
a sensor having an array of polymers capable of detecting the presence of said target compound in an environmental sample, wherein said sensor responds to the target compound by charging the resistance in each polymer resulting in a pattern change in the sensor array;
a processor for receiving the change in resistance, comparing the change in resistance with a previously measures change in resistance, and identifying the presence of the target compound from the pattern change and the concentration of the compound from the amplitude.

19. The device of claim 18 wherein the processor comprises a neural network for comparing the change in resistance with a previously measured change in resistance to find a best match.
